(19) United States
(12) Patent Application Publication
(10) Pub. No.: US 2007/0024050 A1
(43) Pub. Date: Feb. 1, 2007

(54) Security arrangement

(76) Inventors: William Neill White, Bath (GB); David Brian Clouston, Belper (GB)

Correspondence Address: SMITH-HILL AND BEDELL, P.C., 16100 NW CORNELL ROAD, SUITE 220, BEAVERTON, OR, 97006, US

(21) Appl. No.: 10/552,689

(22) PCT Filed: Apr. 8, 2004
(86) PCT No.: PCT/GB04/01540

§ 371 Date: May 26, 2006

(30) Foreign Application Priority Data
Apr. 12, 2003 (GB) 0308530.5

(51) Int. Cl. B42D 15/00

(52) U.S. Cl. 283/81

(57) ABSTRACT

A security arrangement (10) for application to a support. The security arrangement (10) comprises a carrier (12). A first layer (14) of a first material is provided on the carrier. The first layer (14) defines an affixing region (16) substantially devoid of the first material. A second layer (18) of a second material is provided on the first layer (14). An affixing portion of the second layer (18) adheres to the carrier (12) via the affixing region (16).

This invention relates to security arrangements. More particularly, but not exclusively, this invention relates to multi-coloured security arrangements, for example labels and tapes.

There are many circumstances when it is desired to ensure that documents have not been tampered with. Known security products for this purpose comprise a carrier paper which is coated with a suitable monochrome coloured coating layer. The monochrome coating has regions of high and low adherence to the document, so that if it is attempted to remove the regions of high adherence which remain behind on the document. These regions of high adherence can be in the form of letters spelling out, for example, the words VOID or INVALID to provide evidence of tampering.

According to one aspect of this invention there is provided a security arrangement for application to a support, the security arrangement comprising a carrier, a first layer of a first material on the carrier, the first layer defining an affixing region substantially devoid of said first material, and a second layer of a second material on the first layer, wherein an affixing portion of the second layer adheres to the carrier via said affixing region.

According to another aspect of this invention, there is provided a method of forming a security arrangement for application to a support, said method comprising providing a carrier, providing a first layer of a first material on the carrier, the first layer defining an affixing region substantially devoid of said first material, and providing a second layer of a second material on the first layer, wherein an affixing portion of the second layer adheres to the carrier via said affixing region.

Preferably, the carrier comprises a substrate.

The first layer may be less adherable to the carrier than the second layer. When the substrate is removed from the carrier, the affixing portion of the second layer may remain adhered to the carrier.

Preferably the first layer is substantially inadherable to the carrier. The second layer may have a degree of adherability to the carrier which is greater than its degree of adherability to the support.

The carrier may be formed of a film material. The carrier may comprise a plastics material. The plastics material may comprise a polyester. The carrier may of course comprise any other suitable polymeric material, or paper. The carrier may be formed of a light transmitting material, and may be transparent or translucent.

The carrier may be a film of a material having a thickness of less than 0.2 mm, preferably less than 100 microns more preferably in the range of substantially 25 microns to substantially 50 microns.

The first layer may be formed of a light transmissive material, and may be transparent or translucent. Preferably, the first layer is clear. Said first layer may comprise a non-filmic or non-affixing material. A non-filmic or a non-affixing material may be described as a material which does not adhere to the carrier, which may be a film of a polymeric material, for example a polyester film. The first layer may be formed of a material which comprises a non-affixing polymer coating.

A suitable first material for use as the first layer may be a non-affixing ink, which may comprise a UV rotary letter press ink, preferably comprising a short chain polymeric substance, which may have a three-dimensional lattice structure. The first material may comprise a polymeric coating with a short chain molecular structure. In some embodiments, the first material may be pigmented. In other embodiments, the first material may comprise a varnish.

The affixing region of the first layer may have the shape of a letter. In the preferred embodiment, the first layer may comprise a plurality of said affixing regions. Different affixing regions may have the shape of different letters, whereby words can be formed from said letters, such as VOID, OPENED, INVALID or the like. The words preferably provide evidence of the arrangement having been tampered with. Thus, in the preferred embodiment, when the carrier is removed from the support, the affixing portions of the second material remaining adhered to the carrier form words, for example, VOID, OPENED, INVALID or the like, which provide evidence of tampering with the arrangement. Corresponding gaps maybe formed from said affixing portion in the first and said second layers remaining on the support. Thus, in one embodiment, after the carrier has been removed, the support has thereon, the first and second layers, having gaps which spell out the words, for example as indicated above.

Preferably, the first layer is substantially colourless.

The second layer may be formed of a pigmented material. Preferably, the second layer is formed of a plurality of pigmented materials. Said plurality of pigmented materials may comprise a plurality of colours. The second layer may be provided on the first layer in the form of desired patterns, words and/or colours.

The second layer may comprise an affixing material. An affixing material may be described as a material which can adhere to the substrate which may be a film of a polymeric material, for example a polyester film.

The second layer is conveniently formed of a plurality of pigmented polymer coatings, to allow printed matter in a desired pattern to be applied to the first layer as the second layer.

The second material may comprise a UV rotary letter press ink. The second material preferably comprises a long chain polymeric substance, which may have a two-dimensional structure. The second material may comprise a pigmented polymeric coating with a long chain polymeric structure.

The security arrangement may further comprise a release layer. In a first embodiment, the release layer may be applied to the second layer. The release layer may comprise a liner, which may include an adhesive resistant material, for example a non-stick material, such as a silica compound. In the first embodiment, an adhesive may be provided on the release layer. The adhesive is preferably coated thereon and can be transferred to the second layer.

A sealing layer may be provided between the second layer and the adhesive to prevent movement of the adhesive into the second layer. The sealing layer may be a clear polymer for example a matt clear polymer.

In a second embodiment, the sealing layer may be omitted. In the second embodiment an adhesive material may be applied to the second layer to provide an adhesive layer. The adhesive material may be a hot melt adhesive. The adhesive material may be curable by light, such as UV light.

In the second embodiment, the release layer may be applied to the adhesive layer.

In the second embodiment, the first layer may be a polymeric material.

The first layer may comprise a transparent ink.

In one version of the second embodiment, a pattern layer may be applied to the second layer. The adhesive material may be applied over the pattern layer. The pattern layer may comprise a metallised material. The pattern layer may be formed of different colours, letters, numbers and/or the like.

The security arrangement may further include a removal layer to allow the carrier to be removed from the support. The removal layer may be provided on a removal region of the second layer, for example an edge or end region of the second layer. The removal layer may comprise a silica compound, for example a silica varnish.

The second layer may comprise a confuse pattern region to render unreadable any matter printed on the substrate. The confuse pattern region may comprise an alpha-numeric pattern. The confuse pattern region may comprise other types of characters, random marking or shading.

An identification layer may be provided for identification purposes.

The identification layer may include an activatable material which may define an identification pattern. The activatable material may be material activatable by ultra-violet light.

An embodiment of the invention will now be described by way of example only, with reference to the accompanying drawings, in which

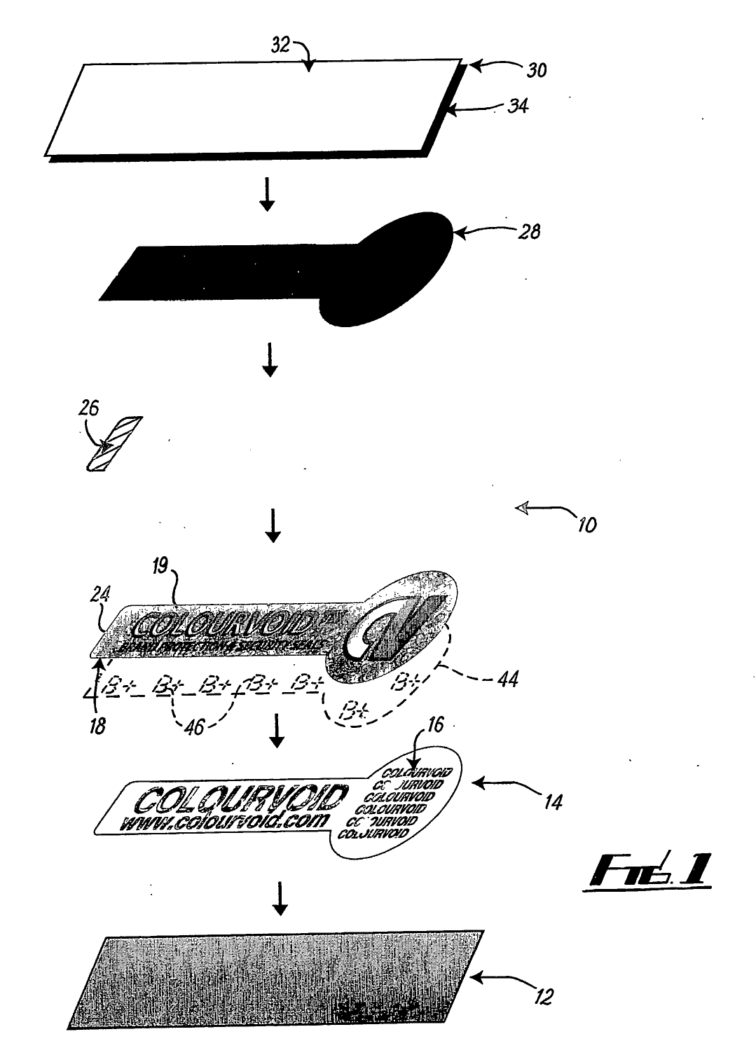

FIG. 1 is an exploded view of the layers of the security arrangement;

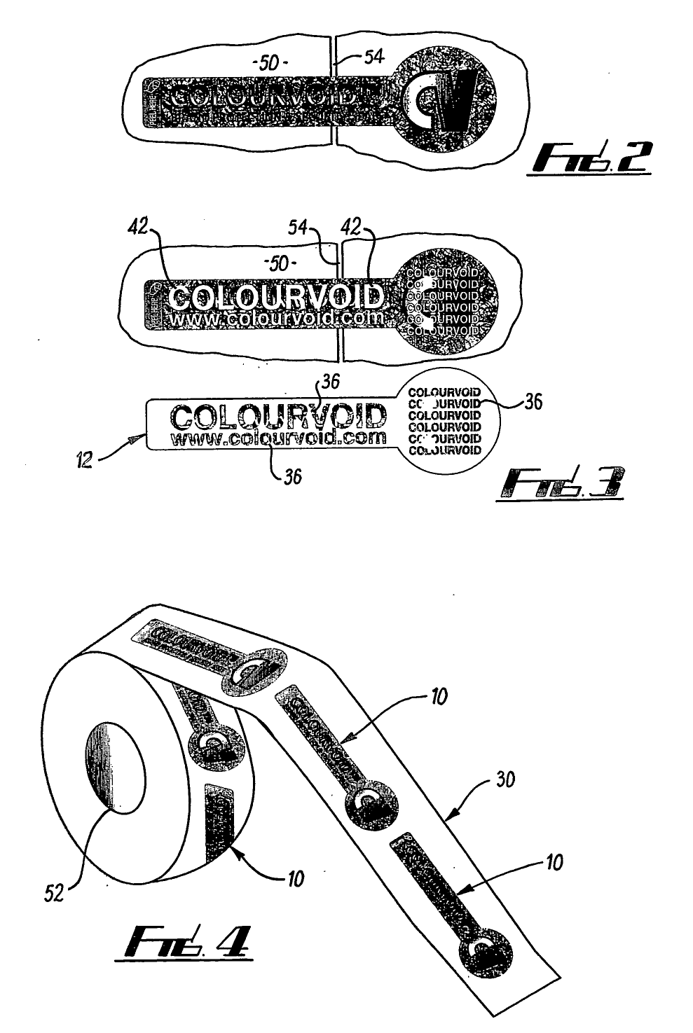

FIG. 2 is a top plan view of a security arrangement shown in FIG. 1;

FIG. 3 is a top plan view of the security arrangement of FIG. 1 in which the substrate has been removed;

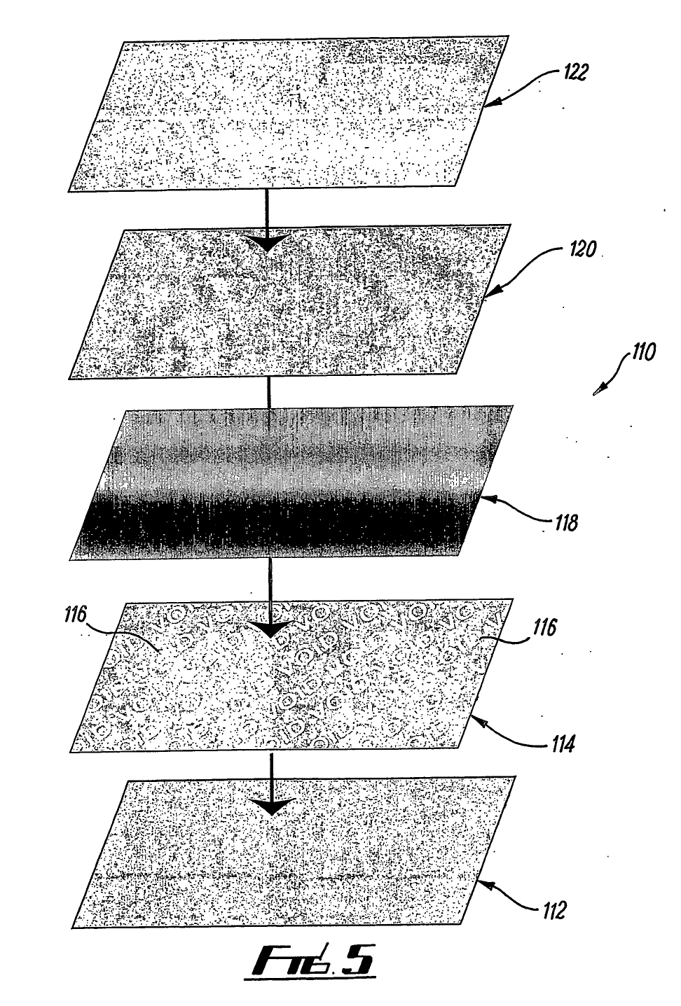

FIG. 4 is a view of a plurality of security arrangements on a release layer;

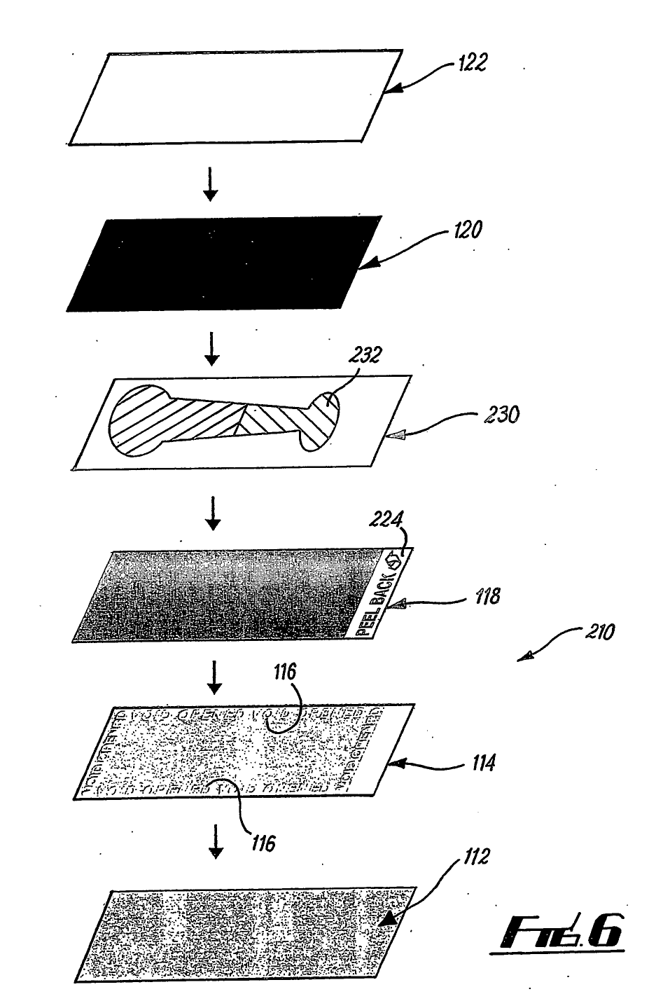

FIG. 5 is an exploded view of a further security arrangement; and

FIG. 6 is an exploded view of yet another security arrangement.

Referring to the drawings, a security arrangement in the form of a security label 10 is shown in FIG. 1 in which the layers are shown separated from each other for clarity. The security label 10 comprises a carrier in the form of a substrate formed of a film 12 of a polyester material which is substantially 50 microns thick.

A first layer 14 of a non-affixing material such as a polymeric coating is printed onto the film 12 by suitable printing means, by example by narrow web rotary letter press UV printing. The first layer 14 is provided with affixing regions 16 which are apertures in the first layer 14. The affixing regions 16 are shaped in the form of letters to spell appropriate words, e.g. VOID, OPENED, or, in the example shown COLOURVOID. The affixing regions 16 are substantially devoid of the non-affixing material. The non-affixing material is a polymer coating which will not adhere to the substrate 12, and may be a UV rotary letter press ink having short chain polymeric molecules, providing a latticed molecular structure.

A second layer 18 formed of an affixing material comprising a plurality of affixing pigmented polymer coatings applied onto the first layer 14.

An affixing pigmented polymer coating is a polymer coating which will adhere to film material such as the substrate 12, and may be a UV rotary letter press ink containing two-dimensional long chain polymeric molecules.

The second layer 18 is applied onto the first layer 14 using the same process as the application of the non-affixing material onto the substrate 12, and may have a patterned region 19. The patterned region 19 may be any desired pattern, for example in the form of a picture or the like, formed of any desired colours using appropriately coloured pigmented polymeric coatings as would be appreciated by the person skilled in the art.

The second layer 18 adheres to the film 12 via the affixing regions 16 in the first layer 14. The affixing regions 16 are represented with a pattern, to demonstrate the appearance of the affixing regions after having been peeled away from the rest of the label 10 when it is adhered to a suitable support (see below).

An example of a suitable pattern is shown in FIG. 2, in which, the patterned region 19 comprises a decorative coloured pattern. Such labels as shown in FIG. 2 could be used, for example, when it is desired to provide tamper evident protection of boxes cartons, item closures, or the like.

In another embodiment, for example, for use in identity cards or passports the second layer could have a central region formed of a clear or colourless transparent ink with a decorative pattern around the edge. In this embodiment, the central region would be arranged over a photograph of the individual to be identified in the identity card or passport.

In a further embodiment, for example, as a security label used with documents to convey confidential information, the second layer 18 could comprise a central region formed of a confuse pattern and an edge region formed of a desired coloured pattern. In this embodiment, the confuse pattern is provided to obscure confidential information printed onto the film 12.

Adjacent the patterned region 19, the second layer 18 is also provided with an instruction region 24 including the words “peel back” to instruct the user as to the part of the label 10 from where to remove the substrate 12 as will be explained below.

A removal layer 26 may be applied over the instruction region 24. To prevent adhesive from being applied in said region to the film 12. The removal layer 26 can be a silicon varnish to which adhesive does not stick.

A sealing layer 28 is applied onto the second layer 18 to prevent adhesive from diffusing into the second layer 18. The sealing layer 18 may be a suitable ink seal.

Finally, a release layer 30 is applied to the label 10 over the second layer 18, with the sealing layer 28 arranged between the release layer 30 and the second layer 18. The release layer 30 comprises a backing sheet 32 and an adhesive 34 applied to one face of the backing sheet 32.

The sealing layer 28 is provided, as explained above, to prevent the adhesive on the backing layer diffusing into the second layer 18, thus allowing the release layer 30 to be removed from the rest of the label 10. The backing sheet 32 may be formed of a suitable silica liner material, so that the adhesive 34 has a greater degree of adherence to the second layer 18 and/or the sealing layer 28 so that the adhesive 34 remains on the second layer 18 and/or the sealing layer 28. This enables the label 10, after the backing sheet 32 has been removed, to be stuck onto a suitable support such as a paper or other suitable article, such as a box or a carton 50.

Referring to FIG. 4, a plurality of the labels 10 as described above are applied to a single release layer 30 which may be wound onto a reel 52 for transport. When it is desired to apply any of the labels to a suitable support, for example, the box or carton 50, one of the labels 10 is removed from the release layer 30 and applied to the box or carton 50. The adhesive 34 remains adhered to the label 10 enabling the label 10 to adhere to the box or carton 50. In use, the label 10 is applied across a gap 54 in the lid of the box or carton 50.

In use, with the embodiment shown in FIGS. 2 and 3, the person in receipt of the box or carton 50 can immediately tell whether the box or carton 50 has been tampered with. Anybody attempting to open the box or carton 50 would need to remove the label 10 applied thereto. This can only be done by peeling away the substrate 12. When this happens, portions 36 of the second layer 18 which are adhered to the substrate 12 via the affixing regions 16 remain so adhered, and are pulled away with the substrate as it is 12 is peeled from the rest of the label 10, adhered to the box or carton 50. The substrate 12, as shown in FIG. 3 carries with it the portions 36 of the second layer as can be seen.

As can be seen from FIG. 3, the word COLOURVOID becomes immediately visible on the substrate 12 and as blank spaces 42 in the remainder of the label 10 on the box or carton 50. Thus, if the person receiving the box or carton 50 notices the word COLOURVOID, he or she will immediately realise that the box or carton 50 has been tampered with and should report it immediately to the company concerned.

There is thus described a security arrangement 10 which has the advantage that it provides a simple method of protecting information and providing evidence of tampering. It can be used in a variety of applications, for example, in addition to the use in providing tamper evident protection of boxes or cartons described above, it can be used in passports for attaching a photograph to the passport by providing a clear central region over the photograph. In addition, it can also be used on letters or other documents to protect confidential information.

Various modifications can be made without departing from the scope of the invention, for example, the sealing layer could be obviated or an identification layer 44 could be provided, for example as shown in broken lines in FIG. 1 over the second layer 14. The identification layer 44 could include a pattern 46 e.g. the letters B+, as shown. The pattern 46 is formed of a material sensitive to UV light which becomes visible when UV light is shone thereon. This would provide suitable identification to the person receiving an article with the label 10 thereon that the label 10 is genuine.

A further embodiment of a security arrangement is shown in FIG. 5 and is in the form of a security label 110. The label 110 comprises a plurality of layers, which are shown separated from one another for clarity. The security label 110 comprises a carrier, in the form of a clear substrate of film 112 of a polyester material, which can be up to or about 75 microns thick.

A first layer 114 of a non-affixing material is printed onto the film 112. The first layer 114 may be a polymeric material, for example in the form of a transparent ink. The polymeric material may be a polymer coating which does not adhere to the film 112, such as a UV rotary letter press ink, which may be the same as or similar to the ink forming the first layer 14 of the embodiment shown in FIG. 1.

The first layer 114 shown in FIG. 5 has affixing regions 116, which are apertures or gaps in the first layer 114. The affixing regions 116 are shaped to spell out, in the embodiment in FIG. 5, the word VOID. Of course, it will be appreciated that the affixing regions 116 could be any other shape, e.g. spelling out different words or even simply in the form of a pattern.

A second layer 118 is applied onto the first layer 114. The second layer 118 is formed of an affixing material which can adhere to the material forming the film 112. A suitable such affixing material is a film e.g. transparent white ink, which may be a polymer coating, such as a UV rotary letter press ink containing two-dimensional long chain polymeric molecules. Alternatively, the second layer can be formed of a suitable varnish.

The second layer 118 adheres to the film 112 through the affixing regions 116 in the first layer 114.

A layer of an adhesive material 120 is then applied to the second layer 118. The adhesive material 120 may be a UV hot melt adhesive, which may be a prepolymer adhesive curable by UV light. It is believed that UV treatment of the adhesive causes cross-linking of the prepolymeric material to effect the aforesaid curing.

The label 110 can be applied to a liner 122 such that the adhesive material contacts the liner 122. The liner 122 may be a release liner formed of a siliconised material, such as a honey siliconised material.

The use of a sealing layer, similar to the sealing layer 28 is not required in the embodiment described above with reference to FIG. 5.

In use, a plurality of labels 110 are applied to a single release liner 122, and wound upon a reel, if desired. The labels 110 can be removed in turn and applied to a suitable support, in a similar way as described above with reference to FIGS. 2 to 4. The adhesive material 120 adheres the label 110 to the support. In the event that any tampering occurs to the support, it would be necessary for an attempt to be made to remove the label 110 therefrom, by peeling away the substrate or film 112. This will result in portions of the second layer 118 remaining adhered to the support, while other portions of the second layer 118 remain adhered to the substrate or film. These other portions were adhered to the substrate 112 through the affixing region 116 in the first layer 114 and are thus removed with the substrate 112 when it is peeled away. As a result, the word VOID appears on the support provides a warning that attempts have been made to tamper with it.

A further embodiment is shown in FIG. 6 and is in the form of yet another security label 210. The label 210 comprises a plurality of layers which are, again, shown separated from one another for clarity.

The security label 210 comprises many of the same features, as shown in FIG. 5 and these have been designated with the same reference numerals. The label 210 differs from the embodiment shown in FIG. 5 by the provision of a peel region 224, which is devoid of the adhesive material 120 and facilitates peeling away of the substrate 112, together with the portions of the second layer 118 adhering thereto through the affixing regions 116.

A further difference is that the label 210 comprises a pattern layer 230 applied to the second layer 118. The pattern layer 230 can comprise a metallised pattern 232 comprised of different colours, letters, numbers and/or the like. The pattern layer is formed using metallic inks, for example as disclosed in published international patent application no. WO 03/095217A1

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A security label comprising: a carrier film; a first layer of a non-affixing polymeric coating printed on the film, the non-affixing polymeric coating comprising a UV rotary letter press ink, and the first layer defining affixing regions providing a first pattern, said affixing regions being substantially devoid of the non-affixing polymeric coating; a second layer of an affixing material comprising a plurality of affixing pigmented polymeric coatings to provide a second pattern on the label; wherein regions of the second layer adhere to the carrier film via the affixing regions of the first layer; and the security label further comprises an adhesive to adhere the label to a support.

2. A security label according to claim 1 wherein the first layer is less adherable to the carrier than the second layer.

3. A security label according to claim 1 wherein when the substrate is removed from the carrier film, the affixing portion of the second layer remains adhered to the carrier film.

4. A security label according to claim 1 wherein the first layer is substantially inadherable to the carrier film.

5. A security label according to claim 1 wherein the second layer has a degree of adherability to the carrier which is greater than its degree of adherability to the support.

6. A security label according to claim 1 wherein the carrier film comprises a plastics material.

7. A security label according to claim 6 wherein the plastics material comprises a polyester.

8. A security label according to claim 1 wherein the carrier film comprises any other suitable polymeric material, or paper.

9. A security label according to claim 1 wherein the carrier film is formed of a light transmitting material.

10. A security label according to claim 1 wherein the carrier film is transparent or translucent.

11. A security label according to claim 1 wherein the carrier film has a thickness of less than 0.2 mm, preferably less than 100 microns.

12. A security label according to claim 11, wherein the thickness is in the range of substantially 25 microns to substantially 50 microns.

13. A security label according to claim 1 wherein the first layer is formed of a light transmissive material.

14. A security label according to claim 13 wherein the first layer is transparent or translucent.

15. A security label according to claim 13, wherein the first layer is clear.

16. A security label according to claim 18 wherein the first layer comprises a film of a polymeric material, for example a polyester film.

17. A security label according to claim 1 wherein the UV rotary letter press ink of the first layer comprises a short chain polymeric substance, having a three-dimensional lattice structure.

18. A security label according to claim 1 wherein the first material comprises a polymeric coating with a short chain molecular structure.

19. A security label according to claim 20 wherein different affixing regions of the first layer have the shape of different letters, whereby words can be formed from said letters.

20. A security label according to claim 1 wherein the second layer comprises a plurality of pigmented polymer coatings, to allow printed matter in a desired pattern to be applied to the first layer as the second layer.

21. A security label according to claim 1 wherein the second material comprises a UV rotary letter press ink, comprising a long chain polymeric substance, having a two-dimensional structure.

22. A security label according to claim 21 wherein the second material comprises a pigmented polymeric coating with a long chain polymeric structure.

23. A security label according to claim 1 further comprising a release layer, provided on the second layer.

24. A security label according to claim 23 wherein the release layer comprises a liner, including an adhesive resistant material.

25. A security label according to claim 24 wherein an adhesive is provided on the release layer, the adhesive being coated thereon and so that it can be transferred to the second layer.

26. A security label according to claim 25 wherein a sealing layer is provided between the second layer and the adhesive to prevent movement of the adhesive into the second layer.

27. A security label according to claim 23 wherein an adhesive material is applied to the second layer to provide an adhesive layer.

28. A security label according to claim 27 wherein the adhesive material comprises a hot melt adhesive, curable by light.

29. A security arrangement according to claim 27 wherein the release layer may be provided on the adhesive layer.

30. A security label according to any of claim 27 wherein a pattern layer is provided on the second layer and the adhesive material is provided on the pattern layer.

31. A security label according to claim 30 wherein the pattern layer comprises a metallised material.

32. A security label according to claim 1 further including a removal layer to allow the carrier to be removed from the support, the removal layer being provided on a removal region of the second layer.

33. A security label according to claim 32 wherein the removal layer comprises a silica compound.

34. A security label according to claim 1 wherein the second layer comprises a confuse pattern region to render unreadable any matter printed on the substrate.

35. A security label according to claim 1 wherein an identification layer is provided for identification purposes.

36. A security label according to claim 35 wherein the identification layer includes an activatable material which defines an identification pattern.

37-45. (canceled)
